(19) United States
(12) Patent Application Publication
(10) Pub. No.: US 2014/0056363 A1
(43) Pub. Date: Feb. 27, 2014

(54) METHOD AND SYSTEM FOR DEBLOCK FILTERING CODED MACROBLOCKS

(71) Applicant: Yedong He, Suzhou (CN)

(72) Inventor: Yedong He, Suzhou (CN)

(21) Appl. No.: 13/682,751

(22) Filed: Nov. 21, 2012

(30) Foreign Application Priority Data
Aug. 23, 2012 (CN) 20121042056.1

(51) Int. Cl. H04N 7/26

(52) U.S. Cl. CPC H04N 19/0089
USPC 375/240.24

(57) ABSTRACT

A method and system for deblock filtering coded macroblocks in compliance with the H.264/AVC standard. The method includes deblock filtering three edges of a first sub-block of the macroblock and deblock filtering both vertical edges of a second sub-block that is adjacent to the first sub-block. The method also performs deblock filtering an upper horizontal edge of the second sub-block to provide a deblock filtered first sub-block. The deblock filtering of the upper horizontal edge of the second sub-block is performed immediately after deblock filtering the three edges and the left vertical edge and right vertical edge of the second sub-block. The method also performs storing the deblock filtered first sub-block in an output buffer before performing any further deblock filtering.

### BACKGROUND OF THE INVENTION

The present invention relates to video data processing and, more particularly, to a method and system for deblock filtering coded macroblocks of video data.

The H.264 Advanced Video Coding (AVC) standard includes data compression techniques that allow transmission of video signals at relatively low bit rates and facilitates efficient storage of video data. In the H.264/AVC standard, each video frame is subdivided and encoded at a macroblock level, where each macroblock is a 16×16 block of pixels. Each macroblock is encoded in ‘intraframe’ mode in which a prediction macroblock is formed based on reconstructed macroblocks in the current frame, or ‘interframe’ mode in which a prediction macroblock is formed based on the macroblocks of the reference frames. The intraframe coding mode applies spatial information within the current frame in which the prediction macroblock is formed from samples in the current frame that have previously encoded, decoded and reconstructed. In contrast, the interframe coding mode utilizes temporal information from previous and/or future reference frames to estimate motion to form the prediction macroblock.

A number of video coding standards including the H.264/AVC standard use block-based coding which is considered relatively efficient but can lead to noticeable discontinuities or artifacts between adjacent blocks and adjacent sub-blocks. If these discontinuities or artifacts are removed or smoothed then the perceived visual resulting picture quality can be improved.

The H.264/AVC standard allows for an optional deblocking filter to remove or smooth the discontinuities or artifacts between adjacent blocks and adjacent sub-blocks. The deblocking filter can be part of a system used either in an encoder as an in-loop filter when coding a signal or as a post-processor for a video decoder when decoding a signal. However, the process of deblocking is memory intensive and when deblocking in compliance with the H.264/AVC standard, the deblocking must be performed in a specific sequence governed by this standard.

### BRIEF DESCRIPTION OF THE DRAWINGS

The invention, together with objects and advantages thereof, may best be understood by reference to the following description of preferred embodiments together with the accompanying drawings in which:

FIG. 1 is a block diagram of an electronic system for deblock filtering coded macroblocks of video data in accordance with a preferred embodiment of the present invention;

FIG. 2 is a schematic diagram of luminance (Y) and chrominance (Cb, Cr) macroblocks 200 illustrating a prior art sequence order of deblocking sub-block edges in compliance with the H.264/AVC standard;

FIG. 3 is a schematic diagram of luminance (Y) and chrominance (Cb, Cr) macroblocks 300 illustrating a sequence order of deblocking sub-block edges in compliance with the H.264/AVC standard and in accordance with a first preferred embodiment of the present invention;

FIG. 4 is a schematic diagram of luminance (Y) and chrominance (Cb, Cr) macroblocks 400 illustrating a sequence order of deblocking sub-block edges in compliance with the H.264/AVC standard and in accordance with a second preferred embodiment of the present invention;

FIGS. 5, 6 and 7 are flow charts illustrating a method for performing deblock filtering of at least one coded macroblock of video data in accordance with the first preferred embodiment of the present invention;

FIGS. 8 and 9 are flow charts illustrating a method of for performing deblock filtering of at least one coded macroblock of video data in accordance with the second preferred embodiment of the present invention; and

FIG. 10 is a schematic diagram illustrating 4×4 pixel arrays that are with each sub-block of a macroblock.

### DETAILED DESCRIPTION OF PREFERRED EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the spirit and scope of the invention. In the drawings, like numerals are used to indicate like elements throughout. Furthermore, terms “comprises,” “comprising,” or any other variation thereof, are intended to cover a non-exclusive inclusion, such that system, circuit, device components and method steps that comprises a list of elements or steps does not include only those elements but may include other elements or steps not expressly listed or inherent to such system, circuit, device components or steps. An element or step proceeded by “comprises . . . a” does not, without more constraints, preclude the existence of additional identical elements or steps that comprises the element or step.

In one embodiment of the present invention there is provided a method for performing deblock filtering of at least one coded macroblock of video data. The method includes deblock filtering a left vertical edge of a first sub-block of said macroblock, deblock filtering a right vertical edge of the first sub-block and deblock filtering an upper horizontal edge of the first sub-block. The method then performs deblock filtering a left vertical edge of a second sub-block of said macroblock, deblock filtering a right vertical edge of the second sub-block and deblock filtering an upper horizontal edge of the second sub-block to provide a deblock filtered first sub-block. The upper horizontal edge of the second sub-block is a lower horizontal edge of the first sub-block. Furthermore, the deblock filtering of the upper horizontal edge of the second sub-block is performed immediately after deblock filtering the left vertical edge, right vertical edge and upper horizontal edge of the first sub-block, and the left vertical edge and right vertical edge of the second sub-block.

In another embodiment of the present invention there is provided a method for performing deblock filtering of at least one coded macroblock of video data. The method includes deblock filtering three edges of a first sub-block of the macroblock and deblock filtering both vertical edges of a second sub-block that is adjacent to the first sub-block. The method also performs deblock filtering of an upper horizontal edge of the second sub-block to provide a deblock filtered first sub-block. The deblock filtering of the upper horizontal edge of the second sub-block is performed immediately after deblock filtering the three edges and the left vertical edge and right vertical edge of the second sub-block. The deblock filtered first sub-block is suitably stored in an output buffer before performing any further deblock filtering.

In yet another embodiment of the present invention there is provided a system for deblock filtering coded macroblocks of video data. The system has an input buffer for storing the macroblocks with a deblocking filter coupled to the input buffer. There is a controller coupled to the deblocking filter and an output buffer is coupled to the deblocking filter. In operation, the controller controls the deblocking filter to perform deblock filtering three edges of a first sub-block of the macroblock and deblock filtering both vertical edges of a second sub-block that is adjacent to the first sub-block. The method also performs deblock filtering of an upper horizontal edge of the second sub-block to provide a deblock filtered first sub-block. The deblock filtering of the upper horizontal edge of the second sub-block is performed immediately after deblock filtering the three edges and the left vertical edge and right vertical edge of the second sub-block. The method also performs storing the deblock filtered first sub-block in an output buffer before performing any further deblock filtering.

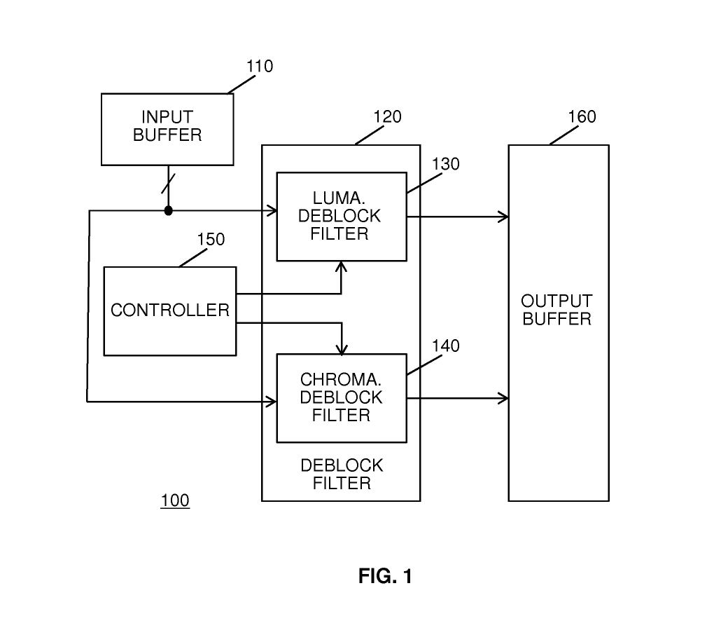

Referring to FIG. 1, a block diagram of an electronic system 100 for deblock filtering coded macroblocks of video data in accordance with a preferred embodiment of the present invention is shown. The system 100 includes an input buffer 110, for storing the macroblocks, and a deblocking filter 120 coupled to the input buffer 110. The deblocking filter as shown includes a luminance (Y) deblocking filter 130 and a chrominance deblocking filter (Cb,Cr) 140. There is a controller 150 coupled to the deblocking filter 120 and an output buffer 160 is coupled to the deblocking filter 120. The system 100 in one embodiment is an encoder for coding a video signal or in another embodiment the system 100 is a post-processor for a video decoder used for decoding an encoded signal.

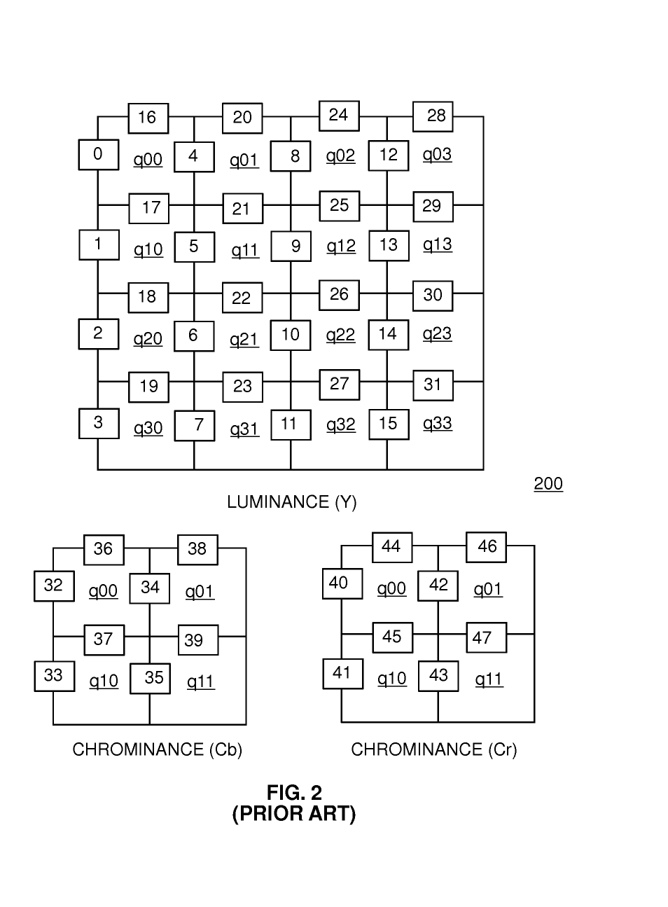

Referring to FIG. 2, a schematic diagram of luminance (Y) and chromimance (Cb, Cr) macroblocks 200 illustrating a prior art sequence order of deblocking sub-block edges in compliance with the H.264/AVC standard is shown. Each luminance (Y) macroblock comprises sub-blocks q00 to q33 and each chrominance (Cb, Cr) macroblock comprises sub-blocks q00 to q11, where each sub-block comprises an array of 16 pixels values (coded pixel data). As shown, four left vertical edges of the luminance (Y) macroblock are deblock filtered starting with the left vertical edge 0 of sub-block q00, then vertical edge 1 of sub-block q10, then vertical edge 2 of sub-block q20 and thereafter vertical edge 3 of sub-block q30. The four right vertical edges of sub-block q00 to q30 are then sequentially deblock filtered in the order 4,5,6,7.

Next the right four vertical edges of sub-blocks q01 to q31 are deblock filtered in the order 8,9,10,11 and thereafter the four right vertical edges of sub-blocks q02 to q32 are deblock filtered in the order 12,13,14,15.

The top four horizontal edges of sub-blocks q00 to q30 are then deblock filtered in the order 16,17,18,19 and thereafter the top four horizontal edges of sub-blocks q01 to q31 are deblock filtered in the order 20,21,22,23. Next the top four horizontal edges of sub-blocks q02 to q32 are deblock filtered in the order 24,25,26,27 and the top four top four horizontal edges of sub-blocks q03 to q33 are then deblock filtered in the order 28,29,30,31.

The chrominance (Cb,Cr) macroblocks are also deblock filtered in a similar way. More specifically the chrominance macroblock (Cb) has its edges deblock filtered firstly in the vertical edge sequence 32,33,34,35 followed by the horizontal edge sequence 36,37,38,39. Similarly, the chrominance macroblock (Cr) has its edges deblock filtered firstly in the vertical edge sequence 40,41,42,43 followed by the horizontal edge sequence 44,45,46,47.

The above prior art sequence order of deblocking sub-block edges, for the luminance macroblock (Y), is relatively memory intensive since partially deblocked versions of all the sub-blocks q00 to q33 must be stored before the first sub-block q00 has been completely deblock filtered and ready to be sent to an output buffer such as buffer 160. Other prior art sequence orders of deblocking sub-block edges also incur similar undesirable storage overheads and need to store at least four partially deblocked sub-blocks before the first sub-block q00 has been completely deblock filtered.

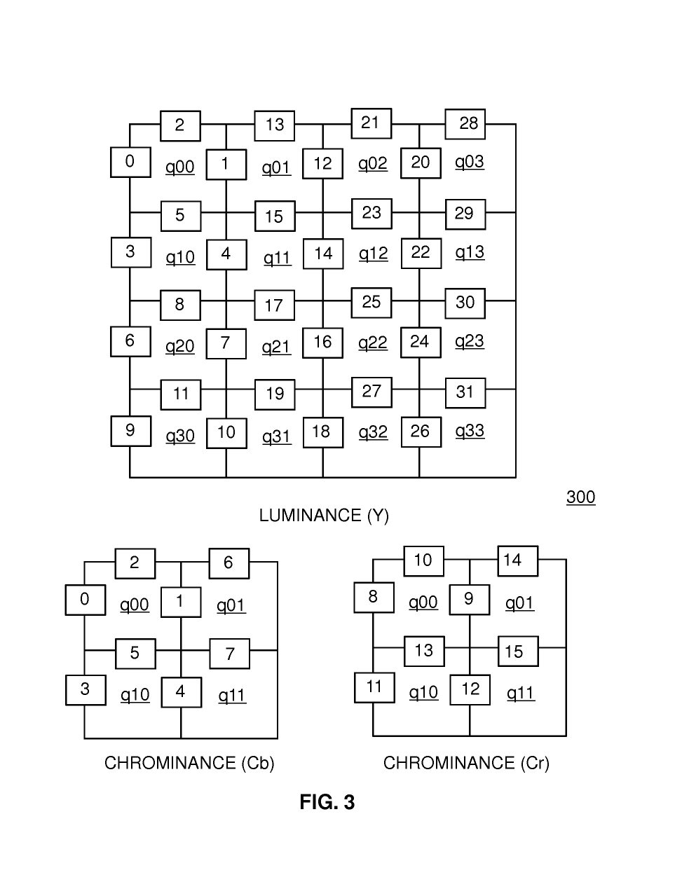

Referring to FIG. 3, a schematic diagram of a luminance (Y) and chrominance (Cb, Cr) macroblocks 300 illustrating a sequence order of deblocking sub-block edges in compliance with the H.264/AVC standard and in accordance with a first preferred embodiment of the present invention is shown. Each luminance (Y) macroblock comprises sub-blocks q00 to q33 and each chrominance (Cb, Cr) macroblock comprises sub-blocks q00 to q11, where each sub-block comprises an array of 16 pixels values (coded pixel data). As shown, a left vertical edge 0 of a first sub-block q00 of the luminance (Y) macroblock is deblock filtered. Next, a right vertical edge 1 of the first sub-block q00 is deblock filtered. An upper horizontal edge 2 of the first sub-block q00 is then deblock filtered and thereafter a left vertical edge 3 of a second sub-block q10 is deblock filtered followed by deblock filtering of a right vertical edge 4 of the second sub-block q10. An upper horizontal edge 5 of the second sub-block q10 is then deblock filtered to provide a deblock filtered first sub-block DF00 (where DF00 is the deblocked version of sub-block q00). The deblock filtered first sub-block DF00 is then stored in the output buffer 160.

A left vertical edge 6 of a third sub-block q20 is then deblock filtered followed by deblock filtering of a right vertical edge 7 of the third sub-block q20. An upper horizontal edge 8 of the third sub-block q20 is then deblock filtered to provide a deblock filtered second sub-block DF10. The deblock filtered second sub-block DF10 is then stored in the output buffer 160. This sequence continues as indicated in the edge order 0 to 31 until all sub-blocks q00 to q33 have been deblock filtered resulting in filtered sub-blocks DF00 to DF33 stored in the output buffer 160. The chrominance (Cb,Cr) macroblocks are also deblock filtered in an identical way wherein a chrominance Cb macroblock is deblock filtered as indicated by edge sequence 0 to 7 and chrominance Cr macroblock is deblock filtered as indicated by edge sequence 8 to 15.

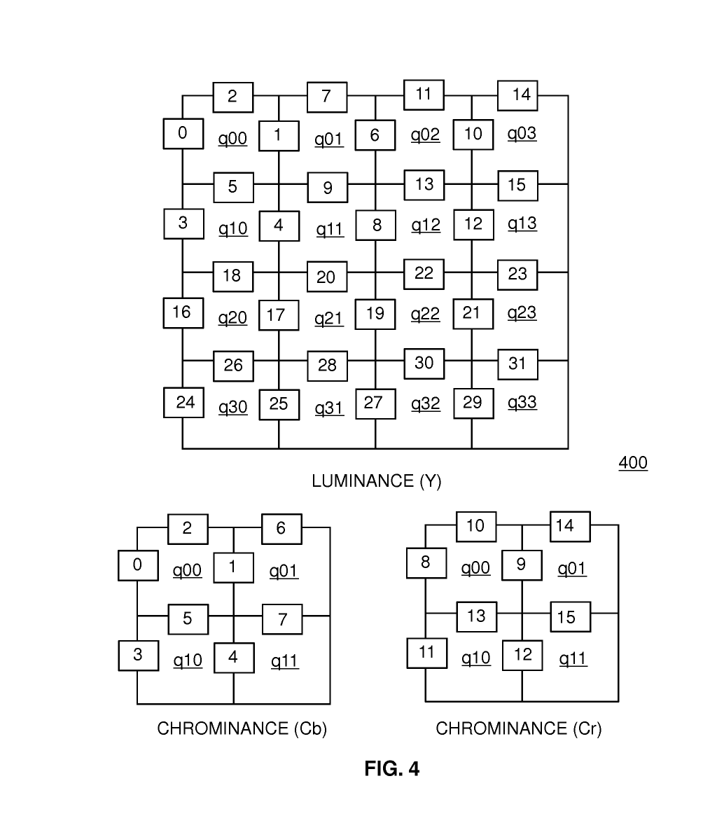

Referring to FIG. 4, a schematic diagram of a luminance (Y) and chrominance (Cb, Cr) macroblocks 400 illustrating a sequence order of deblocking sub-block edges in compliance with the H.264/AVC standard and in accordance with a second preferred embodiment of the present invention is shown. Each luminance (Y) macroblock comprises sub-blocks q00 to q33 and each chrominance (Cb, Cr) macroblock comprises sub-blocks q00 to q11, where each sub-block comprises an array of 16 pixels values (coded pixel data. As shown, a left vertical edge 0 of a first sub-block q00 of the luminance (Y) macroblock is deblock filtered. Next, a right vertical edge 1 of the first sub-block q00 is deblock filtered. An upper horizontal edge 2 of the first sub-block q00 is then deblock filtered and thereafter a left vertical edge 3 of a second sub-block q10 is deblock filtered followed by deblock filtering of a right vertical edge 4 of the second sub-block q10. An upper horizontal edge 5 of the second sub-block q10 is then deblock filtered to provide a deblock filtered first sub-block DF00 (where DF00 is the deblocked version of sub-block q00). The deblock filtered first sub-block DF00 is then stored in the output buffer 160.

A right vertical edge 6 of a third sub-block q01 is then deblock filtered followed by deblock filtering of an upper horizontal edge 7 of the third sub-block q01. A right vertical edge 8 of a fourth sub-block q11 is then deblock filtered and an upper horizontal edge 9 of the fourth sub-block q11 is thereafter deblock filtered to provide a deblock filtered sub-block DF01. The deblock filtered sub-block DF01 is then stored in the output buffer 160. This sequence continues as indicated in the edge order 0 to 31 until all sub-blocks q00 to q33 have been deblock filtered resulting in filtered sub-blocks DF00 to DF33 stored in the output buffer 160. The chrominance (Cb,Cr) macroblocks are also deblock filtered in an identical way wherein a chrominance Cb macroblock is deblock filtered as indicated by edge sequence 0 to 7 and chrominance Cr macroblock is deblock filtered as indicated by edge sequence 8 to 15.

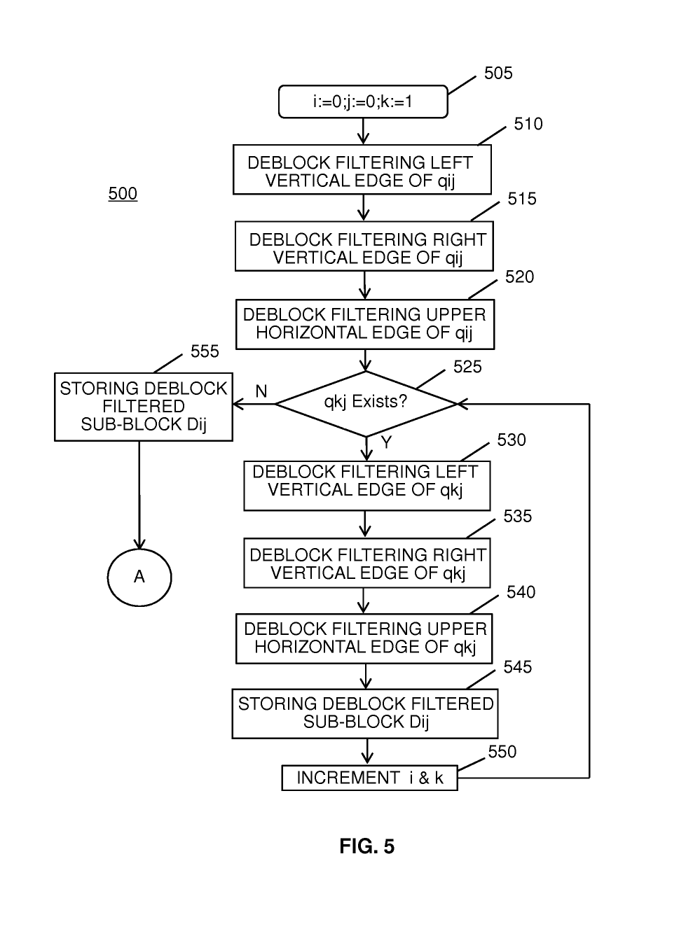

FIG. 5 is a flow chart illustrating a first part of a method 500 for performing deblock filtering of at least one coded macroblock of video data in accordance with the first preferred embodiment of the present invention. The method 500 can be performed on any suitable hardware including the system 100, controlled by the controller 150, and is described with reference to the macroblocks 300. The method 500 at a step 505 sets two counters i,j to zero and a counter k to 1. Next, at a step 510, deblock filtering of a left vertical edge 0 of a first sub-block q00 of the luminance (Y) macroblock 300 is performed. At a step 515, deblock filtering of a right vertical edge 1 of the first sub-block q00 is performed and at step 520 deblock filtering of an upper horizontal edge 2 of the first sub-block q00 is performed.

A test step 525 then determines if a sub-block qkj exists where in the first instance qkj is q10. This sub-block exists and therefore step 530 performs deblock filtering of a left vertical edge 3 of a second sub-block q10 of the luminance (Y) macroblock 300. The method 500 then performs, at step 535, deblock filtering of a right vertical edge 4 of the second sub-block q10 and thereafter, at a step 540, deblock filtering of an upper horizontal edge 5 of the second sub-block q10 is performed. The deblock filtering of the upper horizontal edge 5 results in a deblock filtered first sub-block DF00 (where DF00 is the deblocked version of sub-block q00). This is because the upper horizontal edge 5 of the second sub-block q10 is also a lower horizontal edge of the first sub-block q00 and the deblock filtering of the upper horizontal edge 5 of the second sub-block q10 includes deblock filtering a lower horizontal edge of the first sub-block q00.

As will be apparent to a person skilled in the art, the deblock filtering of the upper horizontal edge 5 of the second sub-block q10 is performed immediately after deblock filtering the left vertical edge 0, right vertical edge 1 and upper horizontal edge 2 of the first sub-block q00, and the left vertical edge 3 and right vertical edge 4 of the second sub-block q10. At a step 545 the method 500 performs storing the deblock filtered first sub-block DF00 in the output buffer 160 and at a step 550 counters i and k are incremented. Test step 525 then again determines if a sub-block qkj exists. Since sub-block q20 exists, steps 530 to 550 are repeated resulting in deblock filtering a left vertical edge 6 of a third sub-block q20, deblock filtering a right vertical edge 7 of the third sub-block q20, and deblock filtering an upper horizontal edge 8 of the third sub-block q20 to provide a deblock filtered second sub-block D10 which is stored in the output buffer 160.

It will be apparent that the upper horizontal 8 edge of the third sub-block q20 is a lower horizontal edge of the second sub-block q10 and the deblock filtering of the upper horizontal edge 8 of the third sub-block q20 is performed immediately after deblock filtering the left vertical edge 6 and right vertical edge 7 of the third sub-block q20. Also, it will be understood that the deblock filtering the upper horizontal edge 8 of the third sub-block q20 includes deblock filtering a lower horizontal edge of the second sub-block q10.

The counters i and k are again incremented at step 550 and the test step 525 will therefore determine that sub-block q30 exists. Since sub-block q30 exists, steps 530 to 550 are repeated resulting in a deblock filtered third sub-block D20 stored in the output buffer 160. This time the test step 525 determines that sub-block q40 does not exist and therefore at a step 555, the deblock filtered sub-block D30 is stored in the output buffer 160 (or any other buffer). After step 555 the method 500 has been performed sequentially on sub-blocks of a left column (where counter j=0) of the luminance (Y) macroblock 300. More specifically, the method 500 is characterised such that at least three sub-blocks q00 to q02 in the left column are completely deblock filtered and stored in the output buffer before any other sub-blocks of the macroblock are completely deblock filtered.

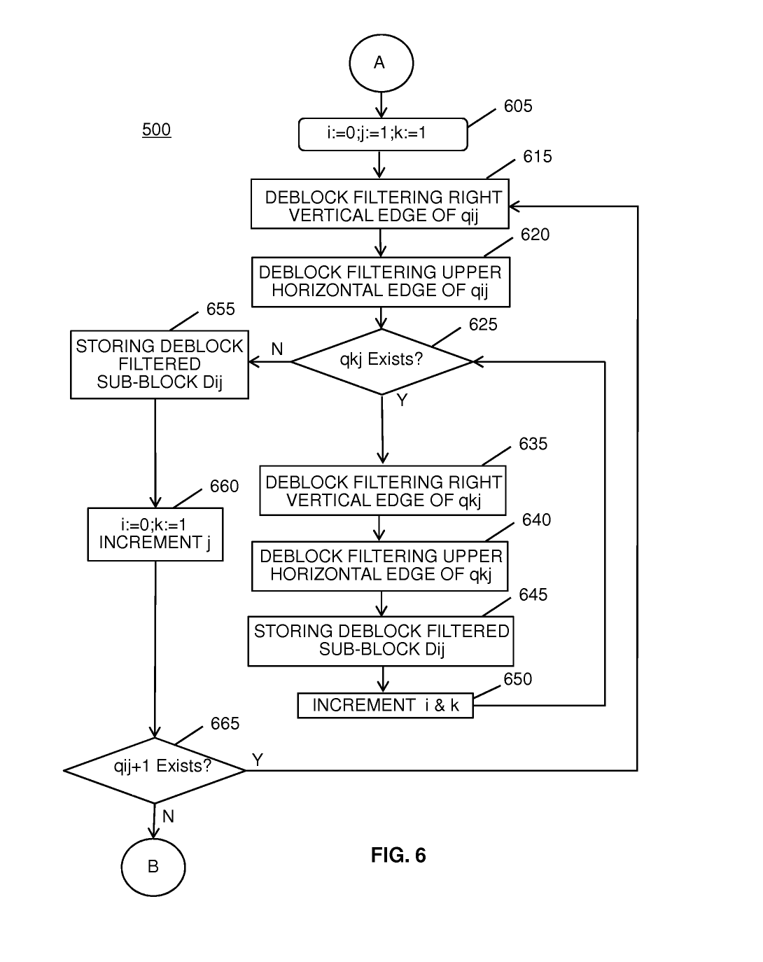

FIG. 6 is a flow chart illustrating a second part of the method 500 for performing deblock filtering of at least one coded macroblock of video data in accordance with the first preferred embodiment of the present invention. The method 500 at a step 605 sets counter i to zero and counters j,k to 1. At a step 615 there is performed deblock filtering of a right vertical edge 12 of sub-block q01 and at a step 620 deblock filtering of an upper horizontal edge 13 of the sub-block q01 is performed.

A test step 625 then determines if a sub-block qkj exists where in the first instance qkj is q11. This sub-block exists and therefore step 635 performs deblock filtering of a right vertical edge 14 of the sub-block q11 and thereafter, at a step 640, deblock filtering of an upper horizontal edge 15 of the sub-block q11 is performed. The deblock filtering of the upper horizontal edge 15 results in a deblock filtered sub-block DF01 (where DF01 is the deblocked version of sub-block q01).

At a step 645 the method 500 performs storing the deblock filtered first sub-block DF01 in the output buffer 160 and at a step 650 counters i and k are incremented. Test step 625 then again determines if a sub-block qkj exists. If sub-block q21 exists, steps 635 to 650 are repeated. This results in deblock filtering a right vertical edge 16 of the sub-block q21 and deblock filtering an upper horizontal edge 17 of the sub-block q21 to provide a deblock filtered sub-block D11 which is stored in the output buffer 160.

The counters i and k are again incremented at step 650 and the test step 625 will therefore determine that sub-block q31 exists. Since sub-block q31 exists, steps 630 to 650 are repeated resulting a deblock filtered sub-block D21 stored in the output buffer 160. This time the test step 625 determines that sub-block q41 does not exist and therefore at a step 655 the deblock filtered sub-block D31 is stored in the output buffer 160 (or any other buffer). At a step 660 counter i is set to zero, counter k is set to 1 and counter j is incremented (counter j=2). A test step 665 then determines if qij+1 exists and since q03 exists the method 500 returns to step 615. When the method 500 returns to step 660, counter i is set to zero, counter k is set to 1 and counter j is incremented (counter j=3) and therefore at test step 665 it is determined that q04 does not exist. The deblock filtering process of sub-blocks of the first three leftmost columns (q00 to q30; q01 to q31; and q02 to q32) of the luminance (Y) macroblock 300 is therefore completed.

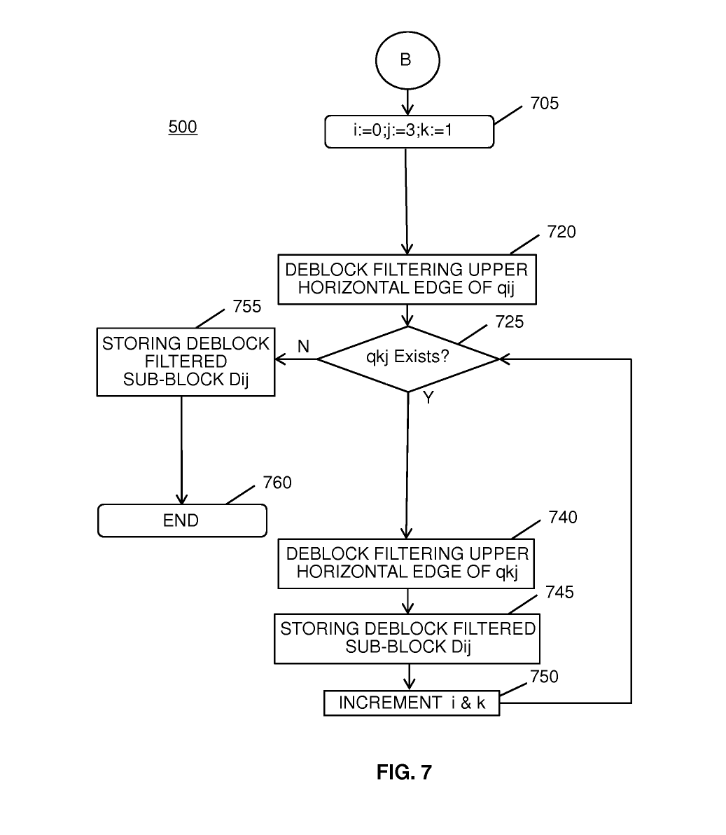

Referring to FIG. 7, a flow chart illustrating a third part of one method 500 for performing deblock filtering of at least one coded macroblock of video data in accordance with the first preferred embodiment of the present invention is shown. The method 500 at a step 705 sets counter i to zero, counter j to 3 and counter k to 1. At a step 720 deblock filtering of an upper horizontal edge 28 of the sub-block q03 is performed.

A test step 725 then determines if a sub-block qkj exists where in the first instance qkj is q13. This sub-block exists and therefore step 740 performs deblock filtering of an upper horizontal edge 29 of the sub-block q13. The deblock filtering of the upper horizontal edge 29 results in a deblock filtered sub-block DF03 (where DF03 is the deblocked version of sub-block q03).

At a step 745 the method 500 performs storing the deblock filtered first sub-block DF03 in the output buffer 160 and at a step 750 counters i and k are incremented. Test step 725 again then determines if a sub-block qkj exists. Since sub-block q23 exists steps 740 to 750 are repeated. This results in deblock filtering an upper horizontal edge 30 of the sub-block q23 to provide a deblock filtered sub-block D13 which is stored in the output buffer 160.

The counters i and k are again incremented at step 750 and the test step 725 will therefore determine that sub-block q33 exists. Since sub-block q33 exists, steps 740 to 750 are repeated resulting in a deblock filtered sub-block D23 stored in the output buffer 160. This time the test step 725 determines that sub-block q43 does not exist and therefore at a step 755 the deblock filtered sub-block D33 is stored in the output buffer 160 (or any other buffer). The method 500 then terminates at a step 760.

It will be apparent that the chrominance (Cb,Cr) macroblocks 300 are also deblock filtered in a similar way using the method 500. Furthermore, the lowermost edges and rightmost edges of the luminance (Y) and chrominance (Cb,Cr) macroblocks 300 are not completely deblock filtered as described in a single pass of the method 500. However, in subsequent passes on adjacent microblocks these lowermost edges and rightmost edges will be completely deblock filtered.

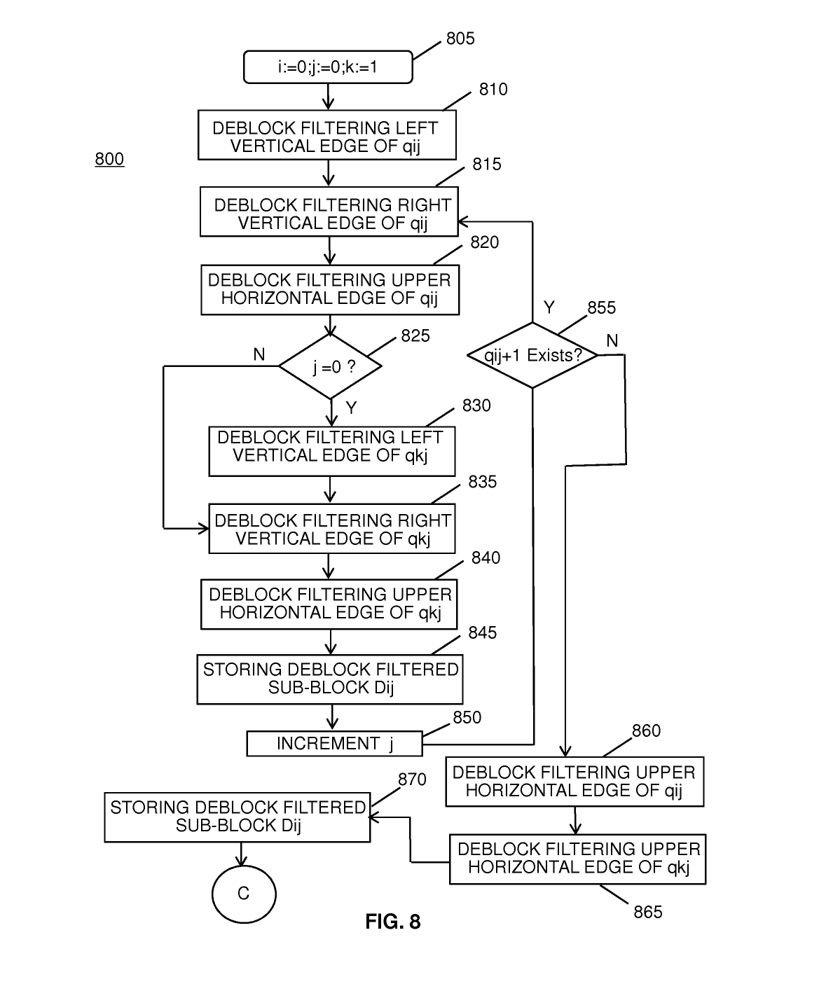

Referring to FIG. 8, a flow chart illustrating a first part of a method 800 for performing deblock filtering of at least one coded macroblock of video data in accordance with the second preferred embodiment of the present invention is shown. The method 800 can be performed on any suitable hardware including the system 100, controlled by the controller 150, and is described with reference to the macroblocks 400. The method 800 at a step 805 sets two counters i,j to zero and a counter k to 1. Next, at a step 810, there is performed deblock filtering a left vertical edge 0 of a first sub-block q00 of the luminance (Y) macroblock 400. At a step 815 there is performed deblock filtering of a right vertical edge 1 of the first sub-block q00 and at a step 820 deblock filtering of an upper horizontal edge 2 of the first sub-block q00 is performed.

A test step 825 then determines if counter j=0. In the first instance j is zero and thus step 830 performs deblock filtering of a left vertical edge 3 of a second sub-block q10 of the luminance (Y) macroblock 300. The method 800 then performs, at step 835, deblock filtering of a right vertical edge 4 of the second sub-block q10 and thereafter, at a step 840, deblock filtering of an upper horizontal edge 5 of the second sub-block q10 is performed. The deblock filtering of the upper horizontal edge 5 results in a deblock filtered first sub-block DF00 (where DF00 is the deblocked version of sub-block q00). This is because the upper horizontal edge 5 of the second sub-block q10 is also a lower horizontal edge of the first sub-block q00 and the deblock filtering of the upper horizontal edge 5 of the second sub-block q10 includes deblock filtering a lower horizontal edge of the first sub-block q00.

At a step 845 the method 800 performs storing the deblock filtered first sub-block DF00 in the output buffer 160 and at a step 850 counter j is incremented and thereafter a test step 855 determines if a sub-block qij+1 exists. Since sub-block q02 exists, steps 815 to 820 and 835 to 850 are repeated (counter j is not equal to zero and therefore step 830 is bypassed). This results in deblock filtering a right vertical edge 6 of a third sub-block q01, deblock filtering an upper horizontal edge 7 of the third sub-block q01, deblock filtering a right vertical edge 8 of a fourth sub-block q11 and deblock filtering an upper horizontal edge 9 of the fourth sub-block q11. After completion of steps 835 to 850 counter j has been incremented and there is provided a deblock filtered sub-block D01 which is stored in the output buffer 160. Furthermore, it will be apparent that a left vertical edge of the third sub-block q01 is the right vertical edge 1 of the first sub-block q00 and a left vertical edge of the fourth sub-block q11 is the right vertical edge 4 of the second sub-block q10.

Test step 855 again determines if a sub-block qij+1 exists. Since sub-block q03 exists, steps 815 to 820 and 835 to 850 are repeated (counter j is not equal to zero and therefore step 830 is bypassed). This results in deblock filtering a right vertical edge 10 of a sub-block q02, deblock filtering an upper horizontal edge 11 of the sub-block q02, deblock filtering a right vertical edge 12 of a sub-block q12 and deblock filtering an upper horizontal edge 13 of the sub-block q12. After completion of steps 835 to 850 counter j has been incremented and there is provided a deblock filtered sub-block D02 which is stored in the output buffer 160. Furthermore, it will be apparent that a left vertical edge of the sub-block q02 is the right vertical edge 6 of the sub-block q01 and a left vertical edge of the sub-block q12 is the right vertical edge 8 of the sub-block q11.

When the method 800 returns to test step 855 sub-block qlj+1 is q04 which does not exist. The method 800 therefore, at step 860, performs deblock filtering of an upper horizontal edge 14 of sub-block q03 and at step 865 deblock filtering of an upper horizontal edge 15 of sub-block q13 is performed. This results in a deblock filtered sub-block D03 which is stored, at step 870, in the output buffer 160 (or any other buffer).

After completion of step 870 the method 800 has sequentially performed deblock filtering on sub-blocks of an upper row q00 to q03 of the luminance (Y) macroblock 400 so that at least three sub-blocks q00, q01 and q02 in the upper row are completely deblock filtered and stored in the output buffer 160 before any other sub-blocks of the luminance macroblock 400 are completely deblock filtered.

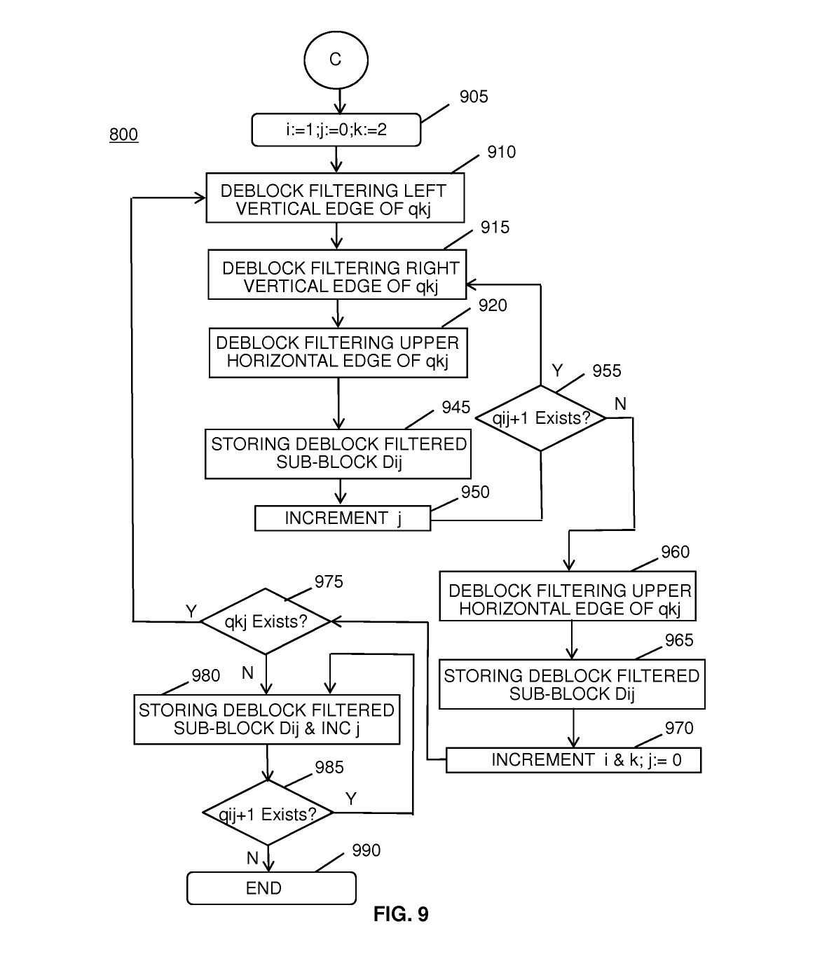

Referring to FIG. 9, a second part of the method 800 for performing deblock filtering of at least one coded macroblock of video data in accordance with the second preferred embodiment of the present invention is shown. The method 800 at a step 905 sets counter i to 1, counter j to 0 and counter k to 2. Next, at a step 910, there is performed deblock filtering a left vertical edge 16 of a sub-block q20 of the luminance (Y) macroblock 400. At a step 915 there is performed deblock filtering of a right vertical edge 17 of the sub-block q20 and at a step 920 deblock filtering of an upper horizontal edge 18 of the sub-block q20 is performed. The deblock filtering of the upper horizontal edge 18 results in a deblock filtered sub-block DF10 which is stored in the output buffer 160 at step 945.

At a step 950 the counter j is incremented and thereafter a test step 955 determines if a sub-block qij+1 exists. Since sub-block q12 exists, steps 915 to 950 are repeated. This results in deblock filtering a right vertical edge 19 of a sub-block q21 and deblock filtering an upper horizontal edge 20 of the sub-block q21. The deblock filtering of the upper horizontal edge 20 results in a deblock filtered sub-block DF11 which is stored in the output buffer 160 at step 945. When it is determined at test step 950 that a sub-block qij+1 does not exist (i.e. that q14 does not exist) the method, at step 960, performs deblock filtering an upper horizontal edge 23 of a sub-block q23 and thereafter and storing deblock filtered sub-block DF13 in the output buffer 160 at step 965.

The counters i and k are incremented and counter j is set to zero at step 970. A test block 975 then determines if a sub-block qkj, since sub-block q30 exists the method 800 returns to step 910. When the test block 975 determines that sub-block qkj does not exist (i.e. that q40 does not exist) steps 980 and 985 are repeated until deblock filtered sub-blocks DF30, DF31, DF32 and DF33 are stored in the output buffer 160 (or any other buffer). The method 800 then ends at step 990.

It will be apparent that the chrominance (Cb,Cr) macroblocks 400 are also deblock filtered in a similar way using the method 800. Furthermore, the lowermost edges and rightmost edges of the luminance (Y) and chrominance (Cb,Cr) macroblocks 400 are not completely deblock filtered as described in a single pass of the method 800. However, in subsequent passes on adjacent microblocks these lowermost edges and rightmost edges will be completely deblock filtered.

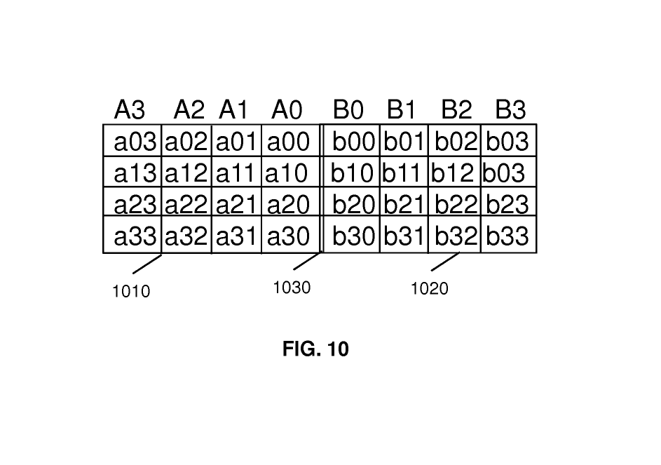

Referring to FIG. 10, a schematic diagram 1000 illustrating 4×4 pixel arrays that are with each sub-block of a macroblock is shown. As shown, there are two adjacent sub-blocks 1010 and 1020 with a common vertical edge 1030. Each sub-block 1010 and 1020 comprises a 4×4 array of 16 pixel values where sub-block 1010 has four columns A0 to A3 of pixel values a00 to a33 and sub-block 1020 has four columns B0 to B3 pixel values b00 to b33.

When performing deblock filtering of the common vertical edge 1030, rows with pixel values ai0 to ai3 and bi0 to bi3 can be calculated concurrently, where i is an integer from 0 to 3. The same applies to all sub-blocks in a macroblock and when considering common horizontal edges, the respective columns of the sub-blocks can be filtered concurrently as will be apparent to a person skilled in the art.

Since deblock filtering is well known it is not discussed in detail. Such filtering involves Boundary Strength BS analysis and alpha α and beta β threshold analysis as will be apparent to a person skilled in the art. However, it is possible to categorize deblock filtering into the following phases:

Phase1->IF BS!=0 THEN read pixels from the input buffer 110; ELSE IF BS=0 THE the filter component is disabled;

Phase2->obtain threshold values α and β;

Phase3->calculate |a0-b0|, |a1-a0|, |b1-b0|, |a2-a0| |b2-b0| and decide to enable or disable the filter;

Phase4->if BS is less than 4 THEN calculate a1′, a0′ and b1′,b0′; ELSE If BS equals 4 THEN calculate a2′, a1′, a0′ and b2′, b1′, b0′; and

Phase 5->store the filtered pixels.

The above phases can be performed in a pipeline fashion for at least some edges in a macroblock, this may save time especially when frame rate speed is critical.

In summary, the present invention provides for deblock filtering three edges of a first sub-block of a macroblock and then deblock filtering both vertical edges of a second sub-block that is adjacent to the first sub-block. The deblock filtering of an upper horizontal edge of the second sub-block to provides a deblock filtered first sub-block, wherein the deblock filtering of the upper horizontal edge of the second sub-block is performed immediately after deblock filtering the three edges and the left vertical edge and right vertical edge of the second sub-block. The deblock filtered first sub-block is stored in the output buffer 160 before performing any further deblock filtering. The methods 500 and 800 comply with the H.264 Advanced Video Coding standard such that for each sub-block, in a macroblock, the sequence of deblock filtering is: left vertical edge; right vertical edge; upper horizontal edge; and lower horizontal edge.

Advantageously, the present invention therefore provides for deblock filtering in compliance with the H.264/AVC standard and reduces or at least alleviates the memory intensive requirements of prior art deblocking methods that are in compliance with the H.264/AVC standard.

The description of the preferred embodiments of the present invention has been presented for purposes of illustration and description, but is not intended to be exhaustive or to limit the invention to the forms disclosed. It will be appreciated by those skilled in the art that changes could be made to the embodiments described above without departing from the broad inventive concept thereof. It is understood, therefore, that this invention is not limited to the particular embodiment disclosed, but covers modifications within the spirit and scope of the present invention as defined by the appended claims.

1. A method for performing deblock filtering of at least one coded macroblock of video data, the method being performed on an electronic system, comprising the steps of:
deblock filtering a left vertical edge of a first sub-block of said macroblock;
deblock filtering a right vertical edge of the first sub-block;
deblock filtering an upper horizontal edge of the first sub-block;
deblock filtering a left vertical edge of a second sub-block of said macroblock;
deblock filtering a right vertical edge of the second sub-block; and
deblock filtering an upper horizontal edge of the second sub-block to provide a deblock filtered first sub-block, wherein the upper horizontal edge of the second sub-block is a lower horizontal edge of the first sub-block and the deblock filtering of the upper horizontal edge of the second sub-block is performed immediately after deblock filtering the left vertical edge, right vertical edge and upper horizontal edge of the first sub-block, and the left vertical edge and right vertical edge of the second sub-block.

2. The method for performing deblock filtering of claim 1, further comprising:
deblock filtering a left vertical edge of a third sub-block of said macroblock;
deblock filtering a right vertical edge of the third sub-block; and
deblock filtering an upper horizontal edge of the third sub-block to provide a deblock filtered second sub-block, wherein the upper horizontal edge of the third sub-block is a lower horizontal edge of the second sub-block and the deblock filtering of the upper horizontal edge of the third sub-block is performed immediately after deblock filtering the left vertical edge and right vertical edge of the third sub-block.

3. The method for performing deblock filtering of claim 2, wherein the deblock filtering the upper horizontal edge of the second sub-block includes deblock filtering a lower horizontal edge of the first sub-block, and the deblock filtering the upper horizontal edge of the third sub-block includes deblock filtering a lower horizontal edge of the second sub-block.

4. The method for performing deblock filtering of claim 2, wherein the method is performed sequentially on sub-blocks of a left column of the macroblock so that at least three sub-blocks in the left column are completely deblock filtered and stored in the output buffer before any other sub-blocks of the macroblock are completely deblock filtered.

5. The method for performing deblock filtering of claim 1, further comprising:
deblock filtering a right vertical edge of a third sub-block;
deblock filtering an upper horizontal edge of the third sub-block;
deblock filtering a right vertical edge of a fourth sub-block; and
deblock filtering an upper horizontal edge of the fourth sub-block, wherein a left vertical edge of the third sub-block is the right vertical edge of the first sub-block and a left vertical edge of the fourth sub-block is the right vertical edge of the second sub-block.

6. The method for performing deblock filtering of claim 5, wherein the deblock filtering of the right vertical edge of the first sub-block includes deblock filtering the left vertical edge of the third sub-block, and the deblock filtering of the right vertical edge of the second sub-block includes deblock filtering the left vertical edge of the fourth sub-block.

7. The method for performing deblock filtering of claim 5, wherein the method is performed sequentially on sub-blocks of an upper row of the macroblock so that at least three sub-blocks in the upper row are completely deblock filtered and stored in the output buffer before any other sub-blocks of the macroblock are completely deblock filtered.

8. The method for performing deblock filtering of claim 1, further comprising storing the deblock filtered first sub-block in an output buffer.

9. The method for performing deblock filtering of claim 1, wherein each sub-block comprises an array of 16 pixel values.

10. The method for performing deblock filtering of claim 1, wherein the method complies with a H.264 Advanced Video Coding standard such that for each sub-block, in the macroblock, the sequence of deblock filtering is: left vertical edge; right vertical edge; upper horizontal edge; and lower horizontal edge.

11. A method for performing deblock filtering of at least one coded macroblock of video data, the method being performed on an electronic system, the method comprising the steps of:
deblock filtering three edges of a first sub-block of the macroblock;
deblock filtering both vertical edges of a second sub-block that is adjacent to the first sub-block;
deblock filtering an upper horizontal edge of the second sub-block to provide a deblock filtered first sub-block, wherein the deblock filtering of the upper horizontal edge of the second sub-block is performed immediately after deblock filtering the three edges and the left vertical edge and right vertical edge of the second sub-block; and
storing the deblock filtered first sub-block in an output buffer before performing any further deblock filtering.

12. The method for performing deblock filtering of claim 11, further comprising:
deblock filtering a left vertical edge of a third sub-block of said macroblock;
deblock filtering a right vertical edge of the third sub-block; and
deblock filtering an upper horizontal edge of the third sub-block to provide a deblock filtered second sub-block, wherein the upper horizontal edge of the third sub-block is a lower horizontal edge of the second sub-block and the deblock filtering of the upper horizontal edge of the third sub-block is performed immediately after deblock filtering the left vertical edge and right vertical edge of the third sub-block.

13. The method for performing deblock filtering of claim 12, wherein the method is performed sequentially on sub-blocks of a left column of the macroblock so that at least three sub-blocks in the left column are completely deblock filtered and stored in the output buffer before any other sub-blocks of the macroblock are completely deblock filtered.

14. The method for performing deblock filtering as claimed in claim 11, wherein the method further includes the steps of:
deblock filtering a right vertical edge of a third sub-block;
deblock filtering an upper horizontal edge of the third sub-block;
deblock filtering a right vertical edge of a fourth sub-block; and
deblock filtering an upper horizontal edge of the fourth sub-block, wherein a left vertical edge of the third sub-block is the right vertical edge of the first sub-block and a left vertical edge of the fourth sub-block is the right vertical edge of the second sub-block.

15. The method for performing deblock filtering of claim 11, wherein the method is sequentially performed on a luminance and associated chrominance macroblocks.

16. A system for deblock filtering coded macroblocks of video data, the system comprising an input buffer for storing the macroblocks, a deblocking filter coupled to the input buffer; a controller coupled to the deblocking filter; and an output buffer coupled to the deblocking filter, wherein in operation the controller controls the deblocking filter by performing the steps of:
deblock filtering three edges of a first sub-block of the macroblock;
deblock filtering both vertical edges of a second sub-block that is adjacent to the first sub-block;
deblock filtering an upper horizontal edge of the second sub-block to provide a deblock filtered first sub-block, wherein the deblock filtering of the upper horizontal edge of the second sub-block is performed immediately after deblock filtering the three edges and the left vertical edge and right vertical edge of the second sub-block; and
storing the deblock filtered first sub-block in an output buffer before performing any further deblock filtering.

17. The system for processing coded macroblocks of claim 16, wherein the controller controls the deblocking filter to perform the steps of:
deblock filtering a left vertical edge of a third sub-block of said macroblock;
deblock filtering a right vertical edge of the third sub-block; and
deblock filtering an upper horizontal edge of the third sub-block to provide a deblock filtered second sub-block, wherein the upper horizontal edge of the third sub-block is a lower horizontal edge of the second sub-block and the deblock filtering of the upper horizontal edge of the third sub-block is performed immediately after deblock filtering the left vertical edge and right vertical edge of the third sub-block.

18. The system for processing coded macroblocks of claim 16, wherein the controller controls the deblocking filter to perform the steps of:
deblock filtering a right vertical edge of a third sub-block;
deblock filtering an upper horizontal edge of the third sub-block;
deblock filtering a right vertical edge of a fourth sub-block; and
deblock filtering an upper horizontal edge of the fourth sub-block, wherein a left vertical edge of the third sub-block is the right vertical edge of the first sub-block and a left vertical edge of the fourth sub-block is the right vertical edge of the second sub-block.

19. The system for processing coded macroblocks of 16, wherein the deblocking filter includes a luminance and chrominance filter.

20. The system for processing coded macroblocks of claim 16, wherein the system performs deblock filtering in compliance with a H.264 Advanced Video Coding standard such that for each sub-block, in the macroblock, the sequence of deblock filtering is: left vertical edge; right vertical edge; upper horizontal edge; and lower horizontal edge.
